(19) United States
(12) Patent Application Publication
(10) Pub. No.: US 2005/0184272 A1
(43) Pub. Date: Aug. 25, 2005

(54) Organic cooling medium and its uses

(76) Inventor: Jeffrey G. Knauf, Sitka, AK (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/932,927

(22) Filed: Sep. 2, 2004

Related U.S. Application Data
(60) Provisional application No. 60/499,803, filed on Sep. 2, 2003.

(51) Int. Cl. C13F 3/00; C08B 30/00; C09K 5/00

(52) U.S. Cl. 252/71; 252/73; 252/74; 252/76; 252/79

(57) ABSTRACT

An organic cooling medium that includes a cooling agent and which may further include a chloride salt. The cooling agent selected from the group consisting of carbohydrates, sugar alcohols, glycosides, maltodextrins, hydrogenated maltodextrins, starch hydrolysates, hydrogentated starch hydrolysates, non-toxic oils, and mixtures thereof.

This application claims priority to prior U.S. Provisional Patent Application Ser. No. 60/499,803, filed Sep. 2, 2003, which is incorporated herein by reference.

### DESCRIPTION OF THE INVENTION

The present invention relates to cooling mediums for use in various applications including, without limitation, the cooling of ice-skating rinks and in building sprinkler systems, cold storage systems, plate freezers, blast freezers, brine freezers, cooling towers, air conditioners and condensers, radiator cooling applications, and heat exchangers.

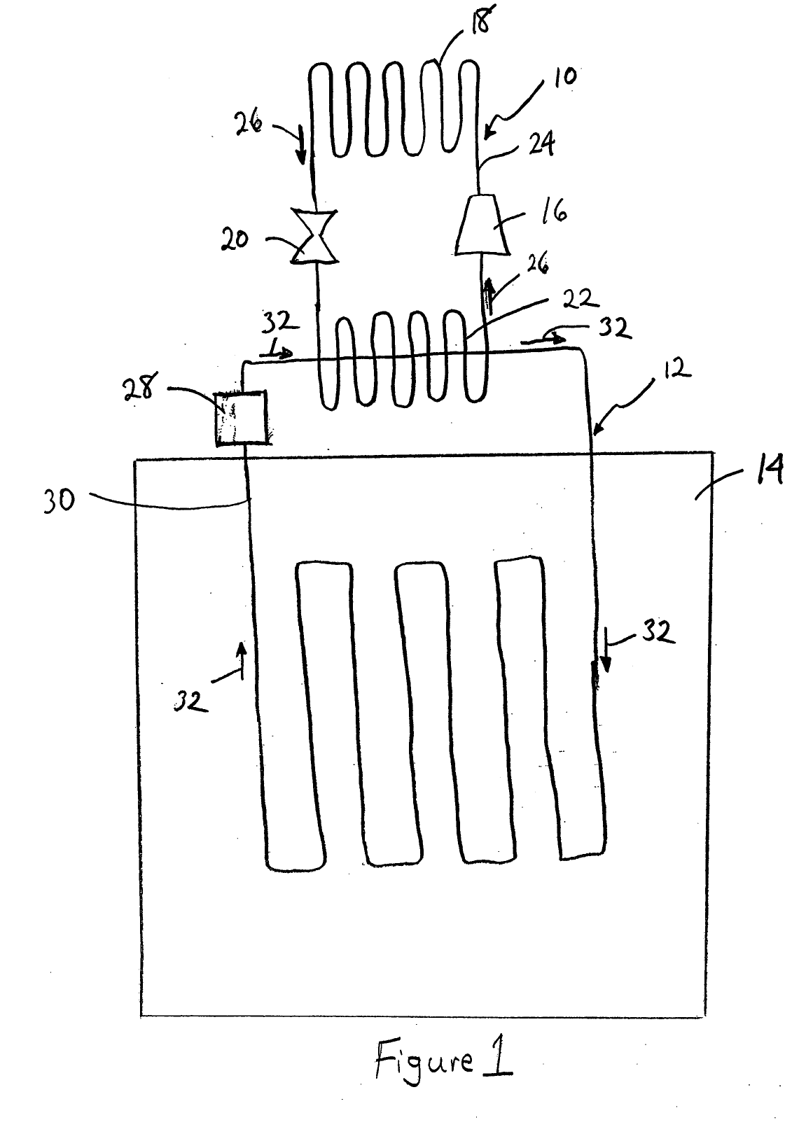

An exemplary use of the invention is depicted generally in FIG. 1 wherein there is depicted a primary refrigeration system 10 operatively connected to a secondary refrigeration system 12, which may be used in numerous applications including the cooling of an ice skating rink 14. The primary refrigeration system 10 is a closed loop system that circulates refrigerant through the system 10 and includes the use of a compressor 16, a condenser 18, an expansion valve 20, an evaporator 22, and tube 24. In operation, the refrigerant flows through tube 24, as indicated by direction arrow 26, through the compressor 16, which raises the pressure of the refrigerant. The refrigerant then flows through the condenser 18, where the refrigerant condenses from vapor form to liquid form, giving off heat in the process. After the condenser 18, the refrigerant flows through the expansion valve 20, where it experiences a pressure drop resulting in a drop in temperature. Finally, the refrigerant goes through the evaporator 22. The refrigerant draws heat from the evaporator 22, which causes the refrigerant to vaporize. In the exemplary application, the evaporator 22 draws heat from the secondary refrigeration system 12. The vaporized refrigerant then returns through the compressor 16 and the cycle is repeated.

The secondary refrigeration system 12 includes a pump 28 and a length of tube 30 that is positioned underneath the surface of the ice-skating rink 14. The pump 28 circulates the cooling medium of the invention, as described below, through the length of tube 30 as indicated by direction arrow 32 to cool the ice-skating rink and maintain the proper ice temperature.

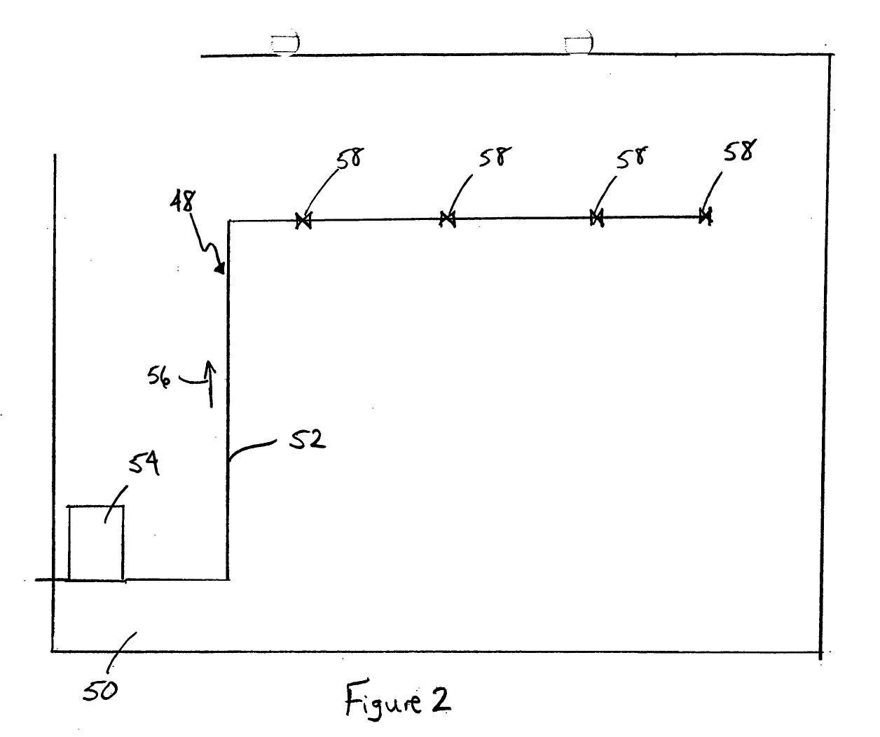

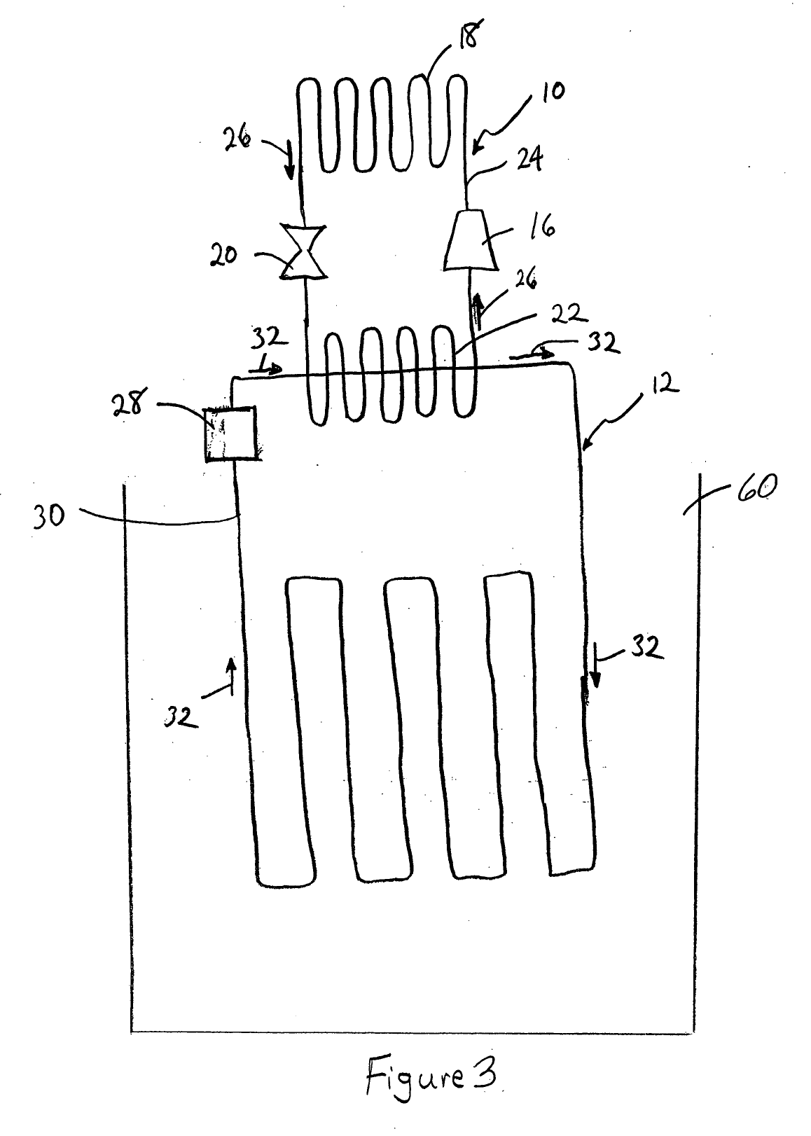

Another exemplary use of the invention is depicted generally in FIG. 2 wherein there is depicted generally a sprinkler system 48 that may be installed in a building 50. The sprinkler system 48 operates when there is a fire situation and provides a fluid to the fire to extinguish the fire. As shown in FIG. 2, the building 50 is generally depicted but may include all types of buildings that use or have installed a sprinkler system. The sprinkler system 48 includes generally a fluid line or tube 52 operatively connected to a fluid source 54. The fluid source 54 provides the fluid, as indicated by direction arrow 56 to a plurality of sprinklers 58 positioned, through the building. In the event of a fire, the fluid is dispersed through the sprinklers 58 and onto the fire, thereby extinguishing the fire. It is known to use a salt-water solution as a fire extinguishing fluid. The known salt-water solution has a lower freezing point to prevent the fluid from freezing within the supply tubes in cold environments. The invention, however, contemplates the use of the cooling medium, as described below, as the fluid used within the sprinkler system 48. In an alternative aspect as shown in FIG. 3, the ice-rink 14 may be replaced with an open tank 60. Materials may be placed directly in the tank 60 for freezing.

The cooling medium of the present invention provides a non-toxic alternative to conventional cooling mediums. Since the present cooling medium is non-toxic it is safer to use, especially in cooling systems which are used in the processing of foods. The cooling medium is further described in U.S. Ser. No. 10/654,590, filed Sep. 2, 2003, which is incorporated herein by reference.

The invention contemplates the use of a cooling medium that includes an organic cooling agent, preferably in combination with a chloride salt. The chloride salt is preferably at least one selected from the group consisting of sodium chloride, magnesium chloride and calcium chloride. For economic reasons, the chloride salt is preferably sodium chloride. Calcium chloride is believed to provide solutions that yield the lowest freezing point and is thus more generally preferred.

The organic cooling agent may be any suitable organic cooling agent. Preferred cooling agents include carbohydrates having a molecular weight ranging from 180-1500, sugar alcohols having a molecular weight ranging from 180-1500, glycosides having a molecular weight ranging from 180-1500, maltodextrins, hydrogenated maltodextrins, starch hydrolyzates, hydrogenated starch hydrolyzates, and non-toxic oils, and any mixture of the foregoing and of other organic cooling agents. Generally, when an oil is used, it is not used in conjunction with a chloride salt or aqueous medium. At least some of the foregoing organic cooling agents are believed to provide beneficial effects when used in conjunction with the freezing of edible marine animals and other food products, in that preservation of the mucosal layer is believed to be enhanced, although the invention should not be deemed limited to any such enhanced effect In addition, certain of the foregoing cooling agents are believed to contribute to a lowering of freezing point in addition to the colligative lowering contributed by the presence of the dissolved material in solution.

If a carbohydrate is used, the carbohydrate may be any suitable carbohydrate, and may include, for instance, glucose, maltose, maltotriose, lactose, fructose, sucrose, and mixtures thereof. The sugar may be selected from monosaccharides, disaccharides, trisaccharides, tetrasaccharides, pentasaccharides, hexasaccharides, and mixtures thereof. Sugar alcohols of the foregoing, such as sorbitol and maltitol, or other sugar alcohols in the weight range provided may be used in conjunction with the invention. The carbohydrate may be provided as a pure solution, but ordinarily is provided in admixture with other materials, in that an industrial waste stream that includes carbohydrates may be used as a source of such carbohydrates. Carbohydrates can be obtained from a wide range of agricultural based products such as those derived from corn, wheat, barley, oats, sugar cane, sugar beets etc. Suitable sugars include, but are not limited to, corn sugar, cane sugar, beet sugar, sorghum sugar, maple sugar, wheat sugar, tapioca sugar, potato sugar, cassava sugar, and manioca sugar.

In an important aspect, the cooling medium has a freezing point of at least −5 F or less, in another aspect −10 F or less, in another aspect −20 F or less, in another aspect −25 F or less, in another aspect −30 F or less, in another aspect −35 F or less, in another aspect −40 F or less, in another aspect −45 F or less, in another aspect −50 F or less, in another aspect −55 F or less, in another aspect −60 F or less, in another aspect −65 F or less, in another aspect −70 F or less, in another aspect −75 F or less, in another aspect −80 F or less, in another aspect −85 F or less, in another aspect −90 F or less, and in another aspect −95 F or less.

In the embodiment where the cooling medium is cooling agent alone without a chloride salt, the cooling medium includes from about 10 to about 80 weight percent, in another aspect, 15 to 75 weight percent, in another aspect, 20 to 70 weight percent, in another aspect, 25 to 65 weight percent, and in another aspect, 30 to 60 weight percent, cooling agent, based on the weight of the cooling medium.

In the embodiment where the cooling medium is a combination of cooling agent and chloride salt, the cooling medium may include the above indicated ranges of cooling agent. Further, the cooling medium may include from about 1 to about 94 weight percent chloride salt, in another aspect, 1 to about 40 weight percent chloride sale, in another aspect, 5 to 30 weight percent, and in another aspect 20 to 30 weight percent chloride salt, based on the weight of the cooling medium.

Preferred embodiments of the invention employ an aqueous solution of molasses Solids. Molasses is the mother liquor left over after crystallization of sugar from materials such as sugar beets and sugar cane. Many grades of molasses are available commercially; one suitable grade is desugared sugar beet molasses, which is molasses from which a second sugar fraction has been taken. As supplied commercially, this product contains 60-75% solids, the solids including carbohydrate, protein, ash, and other components. Further details concerning molasses solids can be found in U.S. Pat. No. 6,080,330 (Bloomer). Most preferably, the molasses solids are used in conjunction with a chloride salt.

In an important aspect, the cooling medium includes from about 1 to about 25 weight percent, in another aspect 10 to 20 weight percent, an in another aspect 12 to 16 weight percent molasses. The cooling medium may further includes from about 16 to 40 weight percent, in another aspect 20 to 30 weight percent, and in another aspect 22 to 26 weight percent chloride salt.

Preferred embodiments of the solution are set forth in the table below, the products being sold commercially by Grain Processing Corporation of Muscatine, Iowa:

| | |
|---|---|
| GEOMELT 55 | 55% desugared sugar beet molasses solids |
| GEOMELT 65 | 60-75% desugared sugar beet molasses |
| | solids |
| GEOMELT S | 27.5% desugared sugar beet molasses |
| | solids/11.5% sodium chloride |
| GEOMELT M | 27.5% desugared sugar beet molasses |
| | solids/15% magnesium chloride |

A highly preferred solution includes 14% desugared sugar beet molasses solids and 25.6% calcium chloride.

The cooling agent also may be a glycoside, in particular a hydrocarbyl aldoside. Suitable hydrocarbyl aldosides may be glucosides, maltosides, maltotriosides, and mixtures thereof. The hydrocarbyl aldoside may be an alkyl aldoside such as alpha-methyl glucoside, beta-methyl glucoside, methyl furanosides, methyl maltosides, methyl maltotriosides, and mixtures thereof. Preferably, the hydrocarbyl aldoside is methyl glucoside.

The materials listed in the following patents may be used in conjunction with the invention. U.S. Pat. Nos. 6,582,622; 6,440,325; 6,436,310; and 6,299,793 purport to describe de-icing and anti-icing compositions containing carbohydrates of less than about 1,500 molecular weight. The carbohydrates include glucose/fructose, disaccharides, trisaccharides, tetrasaccharides, pentasaccharides, hexasaccharides, and mixtures thereof. The carbohydrate molecular weight is from about 180 to 1,500, preferably about 180 to 1,000. The carbohydrates can be obtained from a wide range of agricultural based products such as those derived from corn, wheat, barley, oats, sugar cane, sugar beets etc.

U.S. Pat. No. 6,468,442 describes a de-icing or anti-icing composition using a sugar-water mixture having approximately 15 to 80 percent by weight of a sugar solid, wherein the sugar solid contains approximately 2-60 percent by weight of a monosaccharide. A variety of sugars are disclosed, including corn sugar, cane sugar, beet sugar, sorghum sugar, maple sugar, wheat sugar, tapioca sugar, potato sugar, cassava sugar, and manioca sugar.

U.S. Pat. Nos. 6,544,434 and 6,315,919 purport to describe de-icing compositions containing hydrocarbyl aldosides including alkyl aldosides, furanosides, maltosides, maltotriosides, glucopyranosides and mixtures thereof. Alkyl aldosides disclosed are alpha-methyl glucoside, beta-methyl glucoside, methyl furanosides, methyl maltosides, methyl maltotriosides, and mixtures thereof.

U.S. Pat. No. 6,506,318 purportedly describes de-icing compositions containing a hydroxyl-containing organic compound selected from the group consisting of hydrocarbyl aldosides including glucosides, furanosides, maltosides, maltotriosides, and glucopyranosides, sorbitol and other hydrogenation products of sugars, monosaccharides, maltodextrins and sucrose; maltitol; glycols; monosaccharides; glycerol; and mixtures thereof. Suitable hydrocarbyl aldoside include glucopyranoside sucrose arid alkyl aldosides such as alkyl glucosides, alkyl furanosides, alkyl maltosides, alkyl maltotriosides, alkylglucopyranosides, and mixtures thereof. Other hydrogenation products of sugars, monosaccharides, maltodextrins and sucrose include maltitol, xylitol and mannitol.

U.S. Pat. No. 6,398,979 describes a liquid deicer composition containing molasses solids. The term “molasses solids” refers to the components of molasses that are not water such as various carbohydrates (e.g. sugars) and proteins. Suitable molasses includes cane molasses, citrus molasses, wood molasses, grain molasses, and combinations thereof. U.S. Pat. No. 6,416,648 is directed to a composition useful for preventing the formation of ice or snow on surfaces or for deicing surfaces having ice or snow. The composition is formed from a waste product of the process of removing sugar from molasses, also known as desugared molasses. The sugar may be removed from sugar beet or cane molasses or other types of molasses such as sorghum or citrus.

1. A cooling medium comprising an amount of cooling agent effective for providing a cooling medium having a freezing point of at least −5 F, the cooling agent being selected from the group consisting of carbohydrates, sugar alcohols, glycosides, maltodextrins, hydrogenated maltodextrins, starch hydrolysates, hydrogentated starch hydrolysates, non-toxic oils, and mixtures thereof.

2. The cooling medium of claim 1 wherein the cooling medium comprises from about 10 to about 80 weight percent of the cooling agent.

3. The cooling medium of claim 1 wherein the carbohydrate is selected from the group consisting of glucose, maltose, maltotriose, lactose, fructose, sucrose, and mixtures thereof.

4. The cooling medium of claim 1 wherein the sugar alcohol is selected from the group consisting of sorbitol, maltitol, and mixtures thereof.

5. The cooling medium of claim 1 wherein the glycoside is selected from the group consisting of glucosides, furanosides, maltosides, maltotriosides, glucopyranosides, and mixtures thereof.

6. A cooling medium comprising an amount of cooling agent and chloride salt effective for providing a cooling medium having a freezing point of at least −5 F, the cooling agent being selected from the group consisting of carbohydrates, sugar alcohols, glycosides, maltodextrins, hydrogenated maltodextrins, starch hydrolysates, hydrogentated starch hydrolysates, non-toxic oils, and mixtures thereof, the chloride salt being selected from the group consisting of sodium chloride, magnesium chloride, calcium chloride and mixtures thereof.

7. The cooling medium of claim 6 wherein the cooling medium comprises from about 10 to about 80 weight percent of the cooling agent.

8. The cooling medium of claim 6 wherein the cooling medium comprises from 1 to 40 weight percent chloride salt.

9. The cooling medium of claim 6 wherein the carbohydrate is selected from the group consisting of glucose, maltose, maltotriose, lactose, fructose, sucrose, and mixtures thereof.

10. The cooling medium of claim 6 wherein the sugar alcohol is selected from the group consisting of sorbitol, maltitol, and mixtures thereof.

11. The cooling medium of claim 6 wherein the glycoside is selected from the group consisting of glucosides, furanosides, maltosides, maltotriosides, glucopyranosides, and mixtures thereof.

12. A cooling medium comprising an amount of molasses effective for providing a cooling medium having a freezing point of at least −5 F.

13. The cooling medium of claim 12 further comprising chloride salt.

14. The cooling medium of claim 13 comprising from 16 to 40 weight percent chloride salt.

15. The cooling medium of claim 13 wherein the chloride salt is selected from the group consisting of sodium chloride, magnesium chloride, calcium chloride and mixtures thereof.

16. The cooling medium of claim 12 comprising from 1 to 25 weight percent molasses.

17. The cooling medium of claim 12 wherein the molasses is beet molasses.

18. A method for refrigeration comprising circulating a cooling medium as defined in claim 1, 6 or 12 through a primary and secondary refrigeration system.

19. A method for heat transfer comprising contacting a cooling medium as defined in claim 1, 6 or 12 with a surface or material.
